(19) United States
(12) Patent Application Publication
(10) Pub. No.: US 2008/0302978 A1
(43) Pub. Date: Dec. 11, 2008

(54) Method and Device for Detecting Zones Damageable By Laser Flow

(75) Inventor: Philippe Bouchut, Voreppe (FR)

Correspondence Address: BRINKS HOFER GILSON & LIONE, P.O. BOX 10395, CHICAGO, IL, 60610, US

(73) Assignee: COMMISSARIAT A L'ENERGIE ATOMIQUE, Paris (FR)

(21) Appl. No.: 11/719,716

(22) PCT Filed: Nov. 4, 2005
(86) PCT No.: PCT/FR05/02755

§ 371 Date: Sep. 24, 2007

(30) Foreign Application Priority Data
Nov. 9, 2004 (FR) 0412304

(51) Int. Cl. G01N 21/88; G01N 21/64

(52) U.S. Cl. 250/483.1

(57) ABSTRACT

The invention concerns a method for detecting zones damageable by laser flow including a step of measuring thermoluminescence of the surface to be treated to locate said zones at risk, followed by a step of thermal conditioning of zones thus located.

The present invention relates to the detection of areas at risk of damage by laser flux.

It finds a general application in the field of optics, and more particularly in the detection of areas at risk of damage by laser flux and in the laser treatment of optical surfaces.

Power lasers such as those of the National Ignition Facility (NIF) project developed in the United States and the Megajoule laser developed in France are large scientific instruments in which many (1>92) laser chains converge their energy toward a target of millimeter size. The optical components in each laser chain have large dimensions, typically 400×400 mm², and the constituent materials, the substrates, of the optical components are essentially glass and synthetic silica.

A strong laser flux can damage the surface of optical components. What is more, on subsequent laser shots, this damage increases exponentially. The optical function is then degraded over a larger and larger surface and, through optical propagation, the damage can even cause damage to other optical components in the laser chain. The energy of the laser beam is no longer transported in the specified manner. Laser damage to the surface of optical components has the consequential disadvantage of affecting the service life of the optical components and the maintenance cost of the laser chains.

Methods for producing optical components resistant to laser flux are known already.

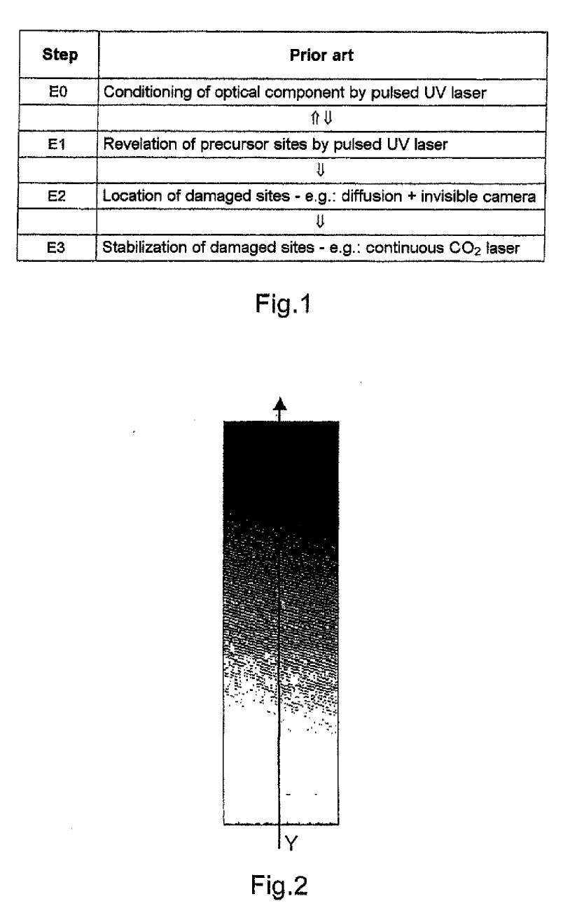

For example, the document U.S. Pat. No. 6,518,539 describes a treatment process for obtaining optical components resistant to laser flux. The main steps of the method of the document U.S. Pat. No. 6,518,539 have been described with reference to FIG. 1.

First of all, in the step E₀) there is provided thermal conditioning of the optical component by pulsed UV laser. Then, in the step E₁), there is provided an operation of revealing precursor sites by pulsed UV laser. In the step E₂), damaged sites are located, for example by diffusion and invisible camera. Finally, in the step E₃), the damaged sites are stabilized, for example by means of a continuous CO₂ laser.

Further details of the step E₀) can be found in the documents US-A-2002/0185611 or U.S. Pat. No. 6,705,125 and further details of the step E₃) can be found in the document U.S. Pat. No. 6,620,333.

More precisely, a multiplicity of technological processes can be used during steps of blanking, trimming and then polishing optical substrates to reduce the density of component surface damage precursor sites.

These “mechanical-chemical” processes can be complemented by an “optical” process, conforming to the step E₀), of pulsed UV laser conditioning to reduce further this density of sites that initiate the damage. For example, the optional step E₀) is a succession of scans of the surface of the component with a pulsed UV laser beam the energy whereof is increased on each successive scan.

However, even if a significant reduction in the density of these precursor sites is obtained, none of the known methods eradicates them completely.

In practice, the optical components are of large size, for example of the order of 1600 cm². Thus even if the density of precursor sites is low, for example 10-2/cm² for a damaging fluence of 10 J/cm² at the wavelength of 351 nm and for a laser pulse of 3 ns duration in synthetic silica, there always remain a few sites on the optical component that will be damaged when they are subjected to the nominal fluence of the laser chain.

Given the exponential growth of the size of the damage site on subsequent laser shots, it is therefore necessary to eradicate completely the laser damage precursor sites.

In the document U.S. Pat. No. 6,518,539, the sites are revealed by scanning the optical component with a UV, excimer or third-harmonic YAG laser beam at the nominal fluence or a slightly higher fluence. In the above document, following the step E₁), the optical component includes a certain number of damaged sites. Those sites are then located in the step E₂) by various methods including diffusion of laser light or intense illumination of the site. In the step E₃) the sites located in this way are “stabilized”, i.e. have applied to them a process that prevents their growth on subsequent laser shots at the nominal fluence. The step E₃) of stabilization of the damaged sites is for example a step of etching by various methods: laser, chemical attack, plasma or other.

It should be noted that the step E₁) of initiation of the damage is a step whose result (the damage) is uncontrolled in terms of size, shape and composition.

This has a deleterious effect on laser flux resistance because the damage generally grows at a fluence lower than that at which it was revealed. By revealing the precursor site by a damaging technique, it is therefore necessary to stabilize it if it is wished to use the optical component afterwards. The step E₃) is therefore indissociable from the step E₁) for use of the optical component.

The technique of revealing precursor sites is not without risks. In effect, a first risk is increasing the “minimal” damage initiated at a site on the occasion of subsequent shots when the optical component is scanned by the laser beam. This can occur because of pointing instabilities or even variability of peak fluence in the laser beam through using pulsed lasers. A second risk, arising from the same problems relating to the use of pulsed lasers, is not revealing all the precursor sites when scanning the optical component.

To determine the efficacy of the process for stabilizing the damage, the optical component must be subjected again to the step E₁) of the process, with the risks referred to above. It should be noted that the yield of the step E₃) is not indicated in the document U.S. Pat. No. 6,518,539. The efficacy of a “generic” stabilization process developed on other optical components is open to question given that each damage is “unique”, because it cannot be reproduced identically. As a result of this there is no way of knowing if the stabilization process applied is effective apart from a laser test at the nominal fluence.

At the end of the process, i.e. following the step E₃, optical flaws therefore remain on the surface of the component at all the sites damaged and then stabilized. Consequently, stabilization does not amount to repairing the surface. Moreover, the wave surface of a large laser beam crossing this interface is disturbed locally at the location of the etching. The impact of this wave front disturbance on the remainder of the laser chain has the disadvantage of also being unknown.

It is moreover known that thermoluminescence is a non-destructive characterization technique that can be used to measure the dose of radiation to which a material has been subjected or to analyze the electronic structure of that material. The thermoluminescence of a material is usually measured in a thermoluminescence analysis machine. For example, the sample is subjected to a thermal ramp generated by an oven and the luminescence caused by this excitation is measured by a photomultiplier.

Recently, a paper by J. L. Lawless, S. K. Lam, Optics Express, Vol. 10, No. 6,291-296, 2002 has shown that thermoluminescence can be induced by locally heating the sample with a CO₂ laser. This has made it possible to demonstrate that various materials (lithium fluoride, silica or porcelain) become thermoluminescent when subjected to radiation. No thermoluminescence is observed in these materials in the absence of radiation.

In fact, all optical components used for power lasers need to be resistant to the laser flux. The specifications for laser flux resistance differ according to the wavelength and the duration of the laser pulse. The cost of the “substrate” materials of optical components, especially if they are of large size, makes an important contribution to the cost of a laser chain. That cost includes the material as well as the surface treatment process or processes used to optically polish the component.

Thus a single laser damage site can quickly render the optical component unusable. Now, at present there is no process for characterizing an optical component surface in terms of laser flux resistance that does not entail causing some damage. Following damage, even if it is of reduced size, stabilization of the damaged site is indispensable to prevent it growing when subjected to the laser flux. Following the stabilization step, there finally remains at the stabilized site a visible flaw on the surface of the component.

The Applicant has therefore addressed the problem of characterizing the surfaces of optical components, situating the sites or areas that are potentially weak in terms of resistance to laser damage, and applying a local process that improves the laser flux resistance, if that is of benefit for the component.

The present invention solves this problem.

Thus it is directed to a method for characterizing the optical surface in terms of laser flux resistance that does not cause any damage and that locates the sites or areas at risk, using the same means for local thermal conditioning of those sites and in situ verification of the efficacy of the conditioning process.

According to a general definition of the invention, the process for non-destructively characterizing the surface of an optical substrate is one of thermoluminescent mapping of the optical surface to be processed, to locate the areas at risk, followed by a step of thermal conditioning of the areas at risk located in this way in order to prevent the laser flux damaging them.

The term “thermoluminescence” or luminescence induced thermally is employed herein in its most general sense: on thermal excitation photons are emitted at the location of the excitation. Thermoluminescence may be intrinsic: linked to physical properties of the material: gap, absorption, thermal conductivity, emissivity, for example. With this definition any body is intrinsically thermoluminescent because if it is in thermodynamic equilibrium it emits photons in accordance with the laws of black body radiation. Thermoluminescence may be extrinsic if it is caused by flaws of the material: electron traps or inclusions, for example. Here the definition of thermoluminescence covers any type of luminescence induced thermally.

Thus thermoluminescent mapping in accordance with the invention locates or highlights areas (flaws) or sites that are weak in terms of laser flux resistance.

In practice, the step of thermal conditioning of the surface to be processed, which follows the step of measurement of thermoluminescence, is preferably a function of said measurement of luminescence, although this is not limiting on the invention.

For example, the thermal conditioning of the surface to be processed is effected by means of a continuous laser. Thus, when located by thermoluminescent mapping in accordance with the invention, potential flaws are processed by thermal conditioning using a standard thermal source or a thermal source identical to that used for the thermoluminescent mapping.

The present invention also consists in a device for detecting areas at risk of damage by laser flux.

According to another important feature, the device includes means for measuring thermoluminescence of the surface to be processed, for locating areas at risk and for thermal conditioning of the areas at risk thus located.

In one embodiment, the thermoluminescence measurement means include a thermal excitation source of the CO₂ laser type.

In another embodiment, the thermoluminescence measurement means further include detection means with a predetermined geometrical relationship to the surface to be processed.

In a further embodiment, the thermoluminescence measurement means further include displacement means for generating movement of the excitation source and the thermoluminescence detection means relative to the surface to be processed.

For the excitation source to be a thermal excitation source, it is necessary for the material that is scanned to absorb the radiation emitted by the laser in order for there to be a local increase in temperature. This local temperature increase is inversely proportional to the thermal conductivity of the material under examination. In this context, the laser beam is focused down to a small size, for example a beam of 300 μm diameter at 1/e. The photons emitted, other than those from the excitation laser, are collected by a photometric device.

Other features and advantages of the invention will become apparent in the light of the detailed description and the drawings, in which:

FIG. 1, already described, represents diagrammatically the steps of a prior art treatment process;

FIG. 2 represents diagrammatically a thermoluminescent map of a selected sample to be treated;

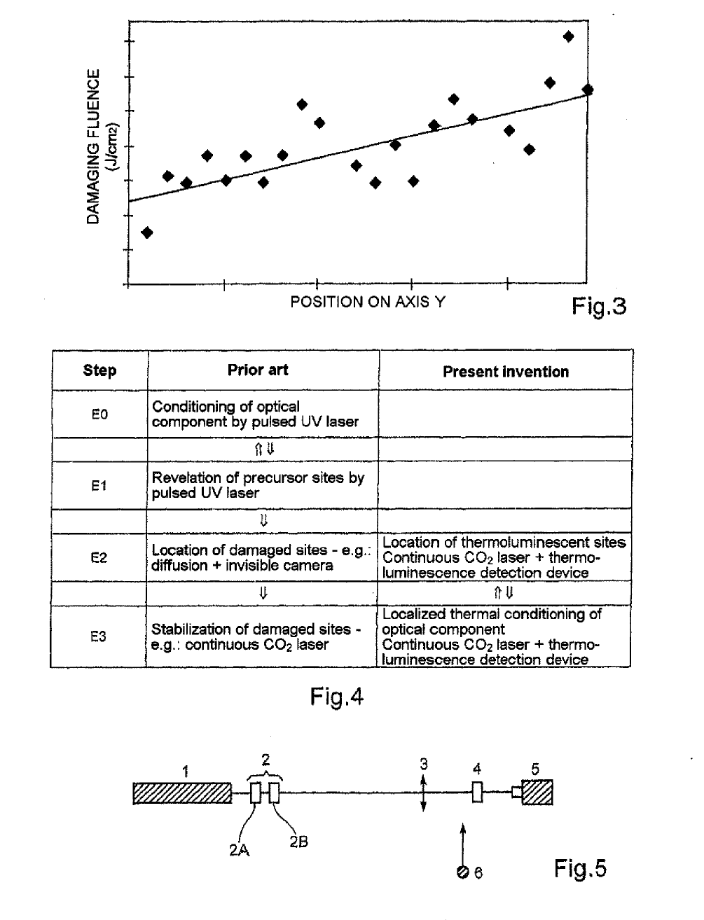

FIG. 3 is a graph showing the damaging fluence as a function of the position along the axis Y of the FIG. 2 map;

FIG. 4 shows the advantages of the method according to the invention over the FIG. 1 prior art process; and

FIG. 5 shows one way in accordance with the invention of producing the thermoluminescent map using a CO₂ laser.

Referring to FIG. 2, the emissive surface area is imaged on a silicon diode. It is possible to associate with each point of the sample examined a photometric signal when the excitation source is moved over the sample or, conversely, the sample is moved within the excitation source. This thermoluminescent map is shown on a sample of suprasil silica.

Referring to FIG. 2, note that in this sample there is a thermoluminescence gradient between the bottom and the top of the map along the axis Y. At the bottom, in white, there is emission of a strong signal and at the top, in black, there is no emission of signal apart from a few specific points. Very fine striations are seen in the intermediate area.

Over the area characterized by thermoluminescence and in the direction represented by the axis Y on the map, the Applicant has tested the laser flux resistance at a wavelength of 355 nm using a pulsed laser in the R/1 mode, i.e. with an energy ramp up to the appearance of damage in the material. The result is shown in the FIG. 3 graph.

Referring to FIG. 3, it is seen that, in moving over the sample, the damaging fluence tends to grow between the strongly luminescent area at the bottom and the weakly luminescent area at the top (the black line is to guide the eye). The Applicant has therefore established a correlation between the thermoluminescence signal and the laser damage. Where the thermoluminescence signal is high the damaging fluence is lower.

Surprisingly, the Applicant has observed that the surface of the silica gives rise to a thermoluminescence signal when it is not irradiated. The Applicant has likewise observed that this thermoluminescence is not homogeneous at the surface of the material, and finally that there exists a correlation between this thermoluminescence and the local laser flux resistance.

On the map described with reference to FIG. 3, it is possible to determine thermoluminescent areas or sites. These areas or sites can be annealed using the same thermal excitation source at a higher linear power.

The annealing process then amounts to thermoluminescent mapping on a smaller scale. The map is ultimately reduced to a point and the annealing effected by positioning the excitation laser beam on the thermoluminescent site and increasing the linear power of the excitation beam until a thermoluminescent signal set point is reached, at which point the excitation is cut off. The thermoluminescence of the site after localized thermal annealing can then be measured by reducing the excitation linear power to the initial characterization value.

Referring to FIG. 4, the advantages stemming from the present invention are great simplification of the steps of the FIG. 1 method for producing surfaces of optical substrates that are laser flux resistant. This simplification impacts on various fields.

Firstly, in the method according to the invention, the optical component conditioning phases, step E₀) and precursor site revelation phases by pulsed UV laser, step E₁), are of no utility.

Secondly, in the U.S. Pat. No. 6,518,539, the steps E₁), E₂) and E₃) are indissociable if it is wished to use the optical component in a laser flux afterwards. The method according to the invention can stop at the step E₂) which is then similar to a component surface sorting step. This can be useful for selecting the best face of an optical component and thus orienting the optical component on the path of the laser beam, as it is known that it is the rear face of an optical component that is more likely to be damaged. This can also be useful for characterizing an optical component surfacing process such as a polishing process since the surface of the material is the result of an interaction between various surfacing processes and the material.

Thirdly, the thermal conditioning phase of the process according to the invention, step E₃), is situated after the step of locating the sites or areas at risk of laser damage. Thus it is not a question of covering the whole of the surface of the optical component during the conditioning step. Optical conditioning by pulsed UV laser is replaced by thermal conditioning by continuous laser. Using a continuous laser for the step of thermal conditioning of the optical component has many advantages over using a pulsed laser, in particular more stable pointing, laser emission mode and power,

Fourthly, the steps E₂) and E₃) can be successively alternated for characterizing the evolution of the thermoluminescence of the conditioned site or area. It is thus possible to adapt the process of conditioning the area at risk in situ. When the map is reduced to a point, it is even possible to slave the conditioning of the site to the thermoluminescence signal by real time feedback. A simple example of this is cutting off the excitation laser beam when a thermoluminescence signal set point is reached.

Fifthly, another advantage of the method according to the invention lies in the fact that no damage is caused to the optical component. The consequences of laser damage to an optical component are harmful to the use of that optical component for the following reasons:

Firstly, the damage is caused at the fluence F1, but grows at a fluence F2<F1, which makes stabilization of the damaged site obligatory if the optical component is to be used at the fluence F1.

Then the laser damage creates flaws extrinsic to the optical component: cracks, crazing, scaling, fused material, evaporated material, etc. of which no length, composition or other parameter is controlled. Each instance of damage is therefore “unique”, because it is not reproducible identically. There is therefore no assurance that the stabilization process used will be reproducible and 100% effective.

Moreover, a site that has been damaged and then stabilized remains a visible flaw on the surface of the component.

Finally, the process being simplified, there result a saving in time and a reduced hardware cost of the installation.

An embodiment of the invention using a continuous CO₂ laser as a thermoluminescence excitation source has been described with reference to FIG. 5.

The emission wavelength of the laser 1 is 10.59 μm, which corresponds to the emission line of the most powerful laser. The excitation wavelength must be adapted to the optical material whose thermoluminescence is to be determined.

In practice, thermoluminescence exists only if there is a rise in temperature of the optical material, if intrinsic flaws or a rise in temperature of an extrinsic flaw are looked for. It is therefore desirable for all or part of the emission spectrum of the excitation source to correspond to the absorption spectrum of the material under test or the extrinsic flaw. In silica, all emission lines of the CO₂ laser from 9.2 to 10.8 μm can be used. The power stability of the excitation source must be good: typically ±1%, minimum to maximum, over the duration of the mapping process.

The laser emission mode may be any mode, Gaussian, flat, annular, etc. but must be stable so as not to disturb the spatial resolution of the map. Finally, the power necessary for exciting luminescence is a linear power that depends on the spatial resolution that is to be obtained for the sample, typically less than 20 watts if the spatial resolution is less than 1 millimeter. The excitation source can be any other laser, lamp, black body source the spectral emission whereof is wholly or partially absorbed by the material under test. Thermal conditioning can be assisted by using a process gas: oxygen, argon or other gas.

A device 2 for controlling and stabilizing the power of the laser 1 is provided. The control and stabilizing device 2 includes a laser power controller that can consist of a half-wave plate 2A followed by a polarizer 2B. The controller adjusts the excitation power to a set point and therefore goes from a characterization mode to a mode of conditioning the optical component. The control and stabilizing device 2 can be complemented by a shutter (not shown) that allows the laser beam to pass or not and a laser power measurement system (not shown) that verifies that the power set point has in fact been reached. The control and stabilizing device 2 can include a device (not shown) for stabilizing the power of the excitation laser in real time.

The optical device further includes a focusing lens 3, for example of ZnSe with an antireflection treatment at the excitation wavelength. The focal length of the lens 3 is adapted to the focal spot to be obtained on the component 4 under test. The size of the focal spot on the surface of the sample 4 can be determined by the knife method.

The surface of the optical component 4 that is to be tested is disposed facing the incident laser beam. The method according to the invention adapts well to optical materials of low thermal conductivity, typically less than 10 W/(m×K), which represents a greater local temperature rise at given incident power and low thermal diffusion, which means that the spatial resolution of the map is not excessively degraded. This method may be adapted to materials such as fused silica, all types of glass and laser crystals, doped or undoped, and materials such as KDP that are used for frequency conversion.

A photometry device 5 collects the photons emitted by the thermoluminescence area. Referring to FIG. 5, it is placed behind the sample 4 under test. This set-up has the advantage of filtering the excitation photons since the silica absorbs radiation at 10.59 μm and detection may be effected in the range of transparency of silica, i.e. from 0.2 to 4 μm wavelength, which caters for many types of sensors, photomultipliers, silicon, InGaAs, PbSe, HgCdTe, etc. in mono-element or camera form. The photometry device 5 can be disposed anywhere that does not intercept the excitation beam. The advantage of putting the photometry device 5 at the front is to benefit from a spectral detection range extending to the far infrared.

The detector 5 used to produce the map described with reference to FIG. 5 is a silicon diode. The enlargement of the zoom that images the thermoluminescent area on the sensor is advantageously adapted both to the excitation spatial resolution and to the spatial resolution of the photometry sensor 5.

In practice, the thermoluminescent mapping is effected by moving the sample in the laser beam or moving the laser beam over the sample by appropriate displacement means (not shown).

In the former case the photometry diagnosis may remain fixed. In the latter case the photometry diagnosis moves with the laser beam or images the area of displacement of the laser beam. For large components the thermoluminescent map may consist of multiple sub-images. At fixed spatial resolution, it may be necessary to increase the excitation power if the scanning speed increases. The sample is scanned two-dimensionally if the excitation is point excitation. To save mapping time, it may be useful to have a linear excitation source, the sample then being scanned in the direction perpendicular to the axis of the excitation source, or a two-dimensional excitation source, in which case there is no longer any need to scan the sample. The homogeneity of power per unit surface area within the thermal excitation beam remains correct.

The method according to the invention can be used to characterize the surface of an optical component at different stages of a polishing process and therefore to adapt the method for application of a strong laser flux or otherwise. The polishing steps can be conducted sequentially on the same optical component, which offers a saving on material cost and simplifies the design of the experiment.

The method according to the invention can be used for sorting and choosing optical faces on the laser beam path. For optical components used in transmission it is judicious to choose the better face, that which is more resistant to the laser flux, as the rear face of the optical component. The least good components can be positioned at places in the laser chain where the specifications in terms of laser flux resistance are less severe. The capacity to sort and order optical components for a laser flux resistance specification can prove to be a great source of savings in terms of maintenance and the service life of laser chain components.

The material cost, for example the synthetic silica cost, can be high for optical components of large size. Replacing synthetic silica substrates with glass, the fabrication cost of which is much lower, and the surfaces whereof have been treated by the method according to the invention, may be envisaged.

1. A method of detection of areas at risk of damage by laser flux comprising measurement of thermoluminescence of a surface to be treated, to locate the areas at risk, followed by thermal conditioning of the areas at risk.

2. The method according to claim 1 wherein thermal conditioning comprises a function of the measurement of thermoluminescence.

3. The method according to claim 1 wherein thermal conditioning comprises thermal conditioning by continuous laser.

4. A device for detection of areas at risk of damage by laser flux comprises means for measurement of thermoluminescence of a surface to be treated to locate the areas at risk and means for thermal conditioning of the areas at risk.

5. The device according to claim 4 wherein the means for measurement of thermoluminescence comprises a thermal excitation source.

6. The device according to claim 5 wherein the thermal excitation source comprises a CO₂ laser.

7. The device according to claim 4 wherein the means for measurement of thermoluminescence further comprises means for detection of thermoluminescence disposed in a predetermined geometrical relationship to the surface to be treated.

8. The device according to claim 7 wherein the means for measurement of thermoluminescence further comprises displacement means adapted to generate movement between an excitation source and the means for measurement of thermoluminescence relative to the surface to be treated.
